(19) United States
(12) Patent Application Publication
(10) Pub. No.: US 2026/0341981 A1
(43) Pub. Date: Oct. 29, 2026

(54) CONTACT ELEMENT

(71) Applicant: BorgWarner Inc., Auburn Hills, MI (US)

(72) Inventors: Christian WEBER, Otterbach (DE); Natalya PLATOVA, Mainz (DE); Björn STITTGEN, Kindenheim (DE)

(21) Appl. No.: 19/661,511

(22) Filed: Apr. 28, 2026

(30) Foreign Application Priority Data
Apr. 28, 2025 (DE) 10 2025 116 208.5

(51) Int. Cl. H01R 4/34; H01R 4/18; H01R 11/12; H01R 43/16

(52) U.S. Cl. CPC H01R 4/34; H01R 4/184; H01R 11/12; H01R 43/16; H01R 2201/10

(57) ABSTRACT

A contact element (11) with a crimp region (13) which is designed for crimping onto an electrical conductor, and with a contact region (15) which has a continuous recess (27) that is radially delimited by a collar (25) on a lower side (23) of the contact region (15), wherein the recess (27) has an internal thread (31).

The invention relates to a contact element, to a stator assembly with such a contact element, and to a method for producing a contact element.

In a three-phase electric motor having a rotor and a stator, the phase windings of the stator are connected via three stator terminal conductors which are connected in an electrically conducting manner to a printed circuit board of power electronics for controlling the electric motor. In a conventional electric motor, the conductors can be connected to the printed circuit board via tulip contacts and copper sleeves with a silver coating.

U.S. Pat. No. 10,965,056 B2 also describes the connection of an electric motor. The interface conductors between the stator and the power electronics described in the document each comprise a hollow conducting body, a stator terminal lug at a first end, which is connected to the windings of the stator, and a busbar at a second end, which is connected to a terminal block.

The object is to provide an improved approach for contacting stator terminal conductors.

The object is achieved by a contact element with the features of claim 1. Moreover specified are a stator assembly with such a contact element and a method for producing a contact element.

The contact element is provided with a crimp region which is designed for crimping onto an electrical conductor, and with a contact region which has a continuous recess that is radially delimited by a collar on a lower side of the contact region, wherein the recess has an internal thread.

The contact element is a crimp contact element, the contact region of which can establish an electrically conducting connection, in particular to a contact pin with an external thread, by means of a threaded connection.

The crimp region serves to electrically connect to a conductor to which the contact element is fastened by way of a crimp connection. The crimp region has a conductor receptacle in which an end region of the conductor is positioned. By deforming the crimp region, the end region of the conductor is squeezed by the crimp region. This creates a mechanical as well as electrical connection between the conductor and the contact element. In one embodiment, the crimp region forms a cavity for the conductor that extends in a longitudinal direction, wherein peripheral regions of the crimp region that extend in the longitudinal direction overlap one another so as to laterally enclose the conductor.

The contact region is designed to establish an electrical connection to a conductor pin, also referred to as a pin, by means of a threaded connection. Therefore, the contact region has a continuous recess with an internal thread for receiving a contact pin end that has an external thread. In comparison to the thickness of the contact region, the recess is lengthened by the collar. The contact pin is screwed into the recess by rotation, so that a stable mechanical connection between the internal thread and the external thread of the contact pin is created.

The current is transmitted primarily via the resting surface between the contact pin and the contact region. An additional current transmission via the thread as an electrical connection is arbitrary and is usually not taken into account in the dimensioning of the contact pin and contact element for the desired current transmission. In one embodiment, the contact region extends from the crimp region in the longitudinal direction and is a sheet-metal region with a rectangular or circular basic shape, in the center of which the recess with the collar is formed. The contact region has a lower side and an opposite upper side from which the contact pin is screwed in. Due to the bush-shaped collar on the lower side, the length of the internal thread is increased. The latter is greater than the sheet thickness of the contact region beyond the recess and the collar. The internal thread advantageously extends along the entire collar length. As a result, the threaded connection is more stable than in the case of an internal thread, the length of which corresponds only to the thickness of the contact region.

Advantageously, a flow-formed sheet metal passage forms the recess and the collar. Here, the contact region is formed from a metal sheet. In a flow-forming process, the recess and the collar are formed by a rotating circular-cylindrical tool with a conical tip, a so-called flow former. The heat generated by the rotating flow former causes a material shift in the contact region, so that, during the flow-forming of the recess, the collar forms on the lower side of the contact region due to the tip of the flow former pressing on the sheet metal on the upper side, said collar defining the lower-side portion of the recess like a bushing. Other terms for flow forming in order to produce such a recess with a collar are flow drilling, flow hole forming, flow hole drilling or flow drill methods. The collar has a frustoconical outer surface and concentrates sufficient material on the lower side of the contact region so as to form an internal thread, the length of which is sufficient for a stable mechanical connection.

In one embodiment, the upper side of the contact region forms a support surface for the contact pin. The support surface is a region of the upper side that is provided for contact with the contact pin. In the state connected to the contact region, the contact pin rests on the support surface. The internal thread is spaced apart from the support surface in a direction perpendicular to the support surface, such that it does not extend as far as the upper side and the support surface.

Provided in one embodiment is a spring region, which is elastically deformable, between the support surface and the internal thread. The spring region is an advantageous feature which is associated with the formation of the conical collar. There is no internal thread provided on the spring region. Such a deformation of the spring region takes place in particular in conjunction with a pre-loading force which is applied by way of the internal thread and acts on the threaded connection. This prevents the threaded connection from being released in the event of a temperature change or vibration.

In one embodiment, the spring region widens radially toward the support surface between the support surface and the internal thread. The spring region extends from the support surface in a funnel-shaped manner to the internal thread, wherein the cross-sectional contour of the funnel can be straight or arcuate.

The contact element is advantageously formed integrally, in particular from a deformed metal sheet. Because of its good electrical properties, copper is a suitable material for the contact element. The contact element as a whole, like its internal thread, can be produced simply and inexpensively.

The contact element is an electrical component of simple construction, which can be produced and assembled in a simple and cost-effective manner. This is associated with low risk and low reject rates. The design is easily scalable and adaptable to the application.

A stator assembly as part of an electric motor comprises contact elements described above. The stator assembly comprises a stator with at least one stator terminal conductor. A contact element is fastened to the end of the stator terminal conductor, which contact element is connected in an electrically conducting manner to a contact pin, wherein the contact pin has a contact pin end with an external thread which engages in the internal thread of the contact element. The phases are actuated via the stator terminal conductors. The phases of the stator are connected by way of the contact elements via the stator terminal conductors to a printed circuit board of power electronics in a cost-effective and robust manner without welding or pressing. Therefore, no complex and expensive machines are required during production either.

In one embodiment, the contact pin has a resting surface which protrudes radially beyond the external thread and rests on the support surface of the crimp region. This contact of the surfaces as contact surfaces brings about the current transmission between the contact pin and the contact element.

Advantageously, the external thread and the internal thread engage in one another in such a manner that, owing to the spring region, a pre-loading force acts on the threaded connection. The elastic deformation of the spring region caused by the threaded connection acts via the internal thread on the screwed-in contact pin and applies a pre-load to the threaded connection.

In the stator assembly with the contact elements described, the costs for the components for the connection to the stator are minor. The contact element can be produced easily and thus inexpensively. It is advantageously manufactured from a copper sheet and has a thermally drilled, i.e. flow-formed, hole with a thread. Neither milling nor complicated assembly is required. The contact pin has an external thread at its end region and can likewise be produced in a simple manner. The assembly process provides for a screw connection. No high compressive forces, no thermal processes, e.g. welding, and no expensive apparatuses are required.

A method according to the invention for producing a contact element with a crimp region and a contact region provides forming a recess in the contact region and a collar which radially delimits the recess on a lower side of the contact region by means of flow forming and forming an internal thread in the recess. The excess material for forming the recess is displaced to the lower side of the sheet metal region and forms a conical collar on the lower side, through which the recess extends. Because of the collar, a thread can be formed, the length of which extends beyond the thickness of the sheet metal. A further effect of this method is the formation of the spring region in which the recess widens, which is associated with the production of the recess and collar. By virtue of its deformation when the contact pin is screwed in, the spring region makes it possible to brace the contact region relative to the contact pin. This prevents the possible release of the contact pin as a result of temperature changes or vibrations. Subsequent potting of the contact elements connected to the contact pins additionally increases the robustness.

Some exemplary embodiments will be discussed in more detail hereunder on the basis of the drawing, in which:

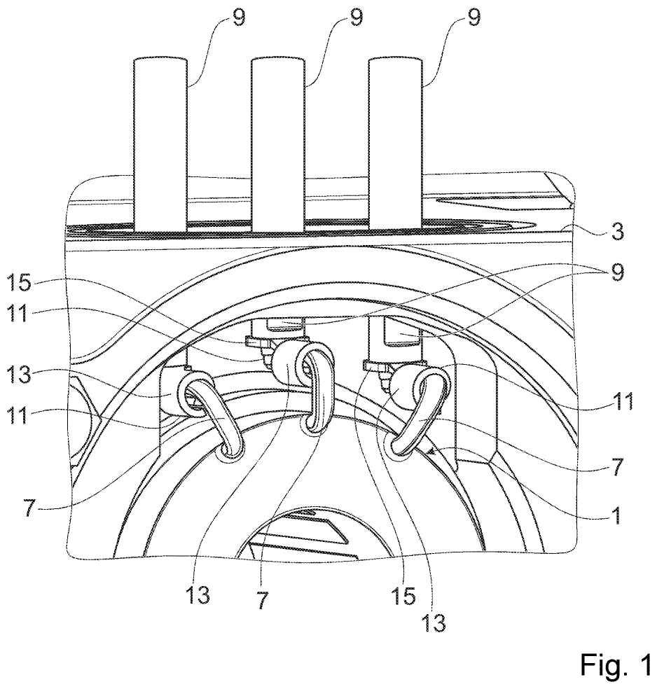

FIG. 1 shows a three-dimensional view of a detail of an exemplary embodiment of an electric motor,

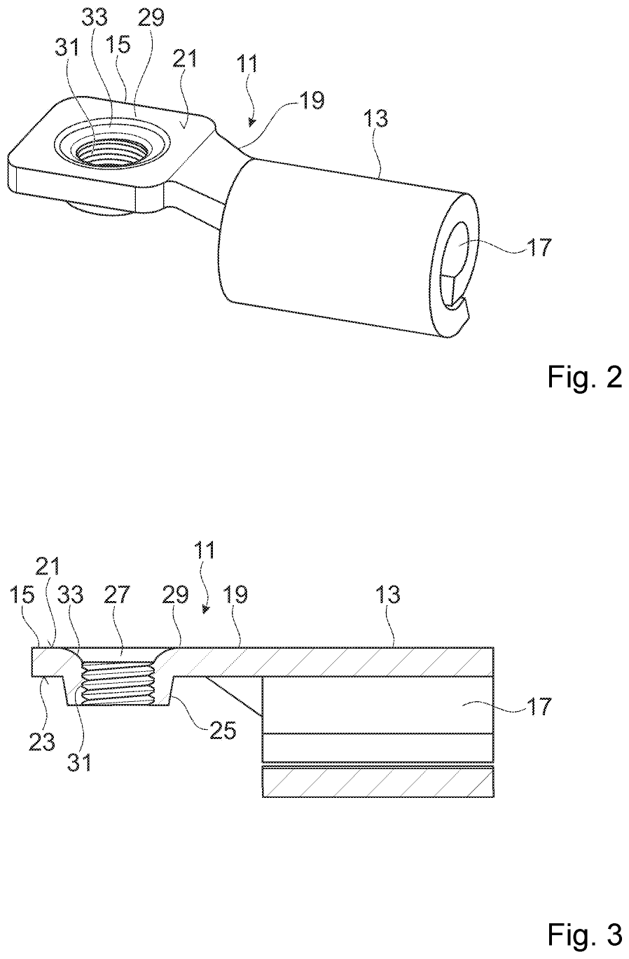

FIG. 2 shows an exemplary embodiment of a contact element in a three-dimensional lateral view,

FIG. 3 shows the contact element from FIG. 2 in a sectional view,

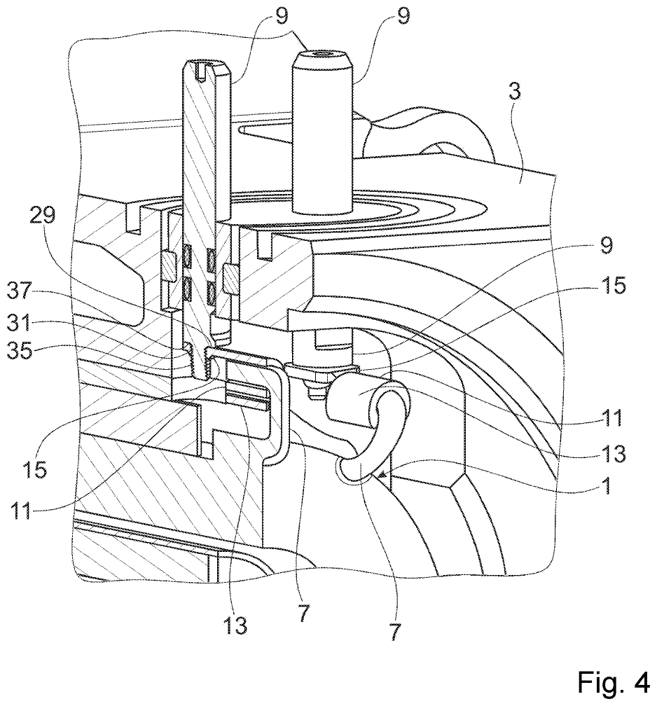

FIG. 4 shows a sectional view through a three-dimensional detailed illustration of the electric motor,

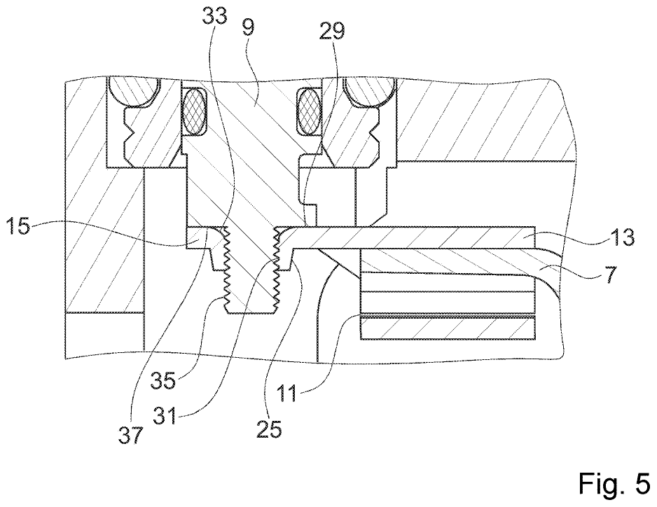

FIG. 5 shows a sectional view through a contact element connected to the contact pin, and

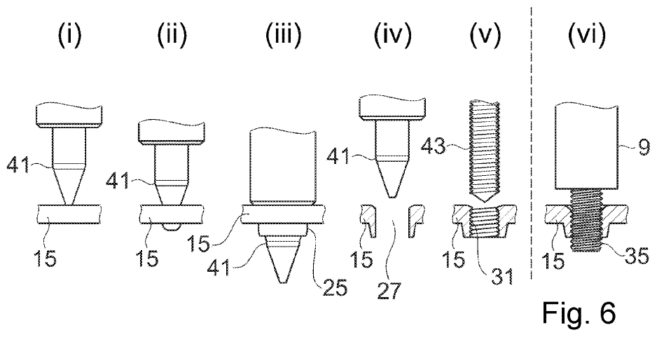

FIG. 6 shows a visualization of the formation of recess and collar by flow forming.

In the figures, components that are identical or have an equivalent function are provided with the same reference signs.

FIG. 1 shows a three-dimensional view of a detail of an electric motor with a stator 1 in a housing 3. The stator 1 comprises stator windings of the three phases and stator terminal conductors 7 which protrude from the stator 1 at the end side. The three stator terminal conductors 7 are provided for actuating the three phases. Each stator terminal conductor 7 comprises a bundle of conductor wires that are sheathed by an insulation material. For connection to a printed circuit board (not illustrated in FIG. 1) outside the housing 3, three contact pins 9 which protrude through the housing 3 are provided. Each stator terminal conductor 7 is connected in an electrically conducting manner to one of the contact pins 9 by means of a contact element 11.

Each contact element 11 has a crimp region 13 and a contact region 15. The crimp region 13 has a hollow cylindrical basic shape, in the cavity of which an end region of one of the stator terminal conductors 7 is squeezed in such a way that a mechanical and electrical connection is formed. Crimping can be performed by means of a hot crimping process in which the insulation at the end region of the stator terminal conductor 7 melts due to heat and the end region is squeezed in the crimp region 13.

FIG. 2 shows an exemplary embodiment of a contact element 11 in a three-dimensional lateral view. FIG. 3 shows a section in the longitudinal direction through the contact element 11. The figures will be described together hereunder.

The contact element 11 comprises a crimp region 13 and a contact region 15. It is made of sheet metal by stamping and forming. The contact element 11 can be made, for example, of copper or any other material. The crimp region 13 is a rectangular sheet-metal region with outer peripheral regions extending in the longitudinal direction. The sheet-metal region is rolled to form the hollow cylinder, such that the peripheral regions overlap one another. The cavity formed by the crimp region 13 is a conductor receptacle 17 into which the end region of the conductor to be contacted is introduced. After the conductor has been introduced, the crimp region 13 is deformed, in particular compressed, by a suitable tool, for example crimping pliers, and pressed conjointly with the conductor.

The contact region 15 extends from the crimp region 13 in the longitudinal direction. A web 19 connects the crimp region 13 and the contact region 15. In the example illustrated, the contact region 15 is a rectangular sheet-metal region with radiused corners. However, the potential design of the contact region 15 is not limited to this exemplary shape.

The contact region 15 has an upper side 21 and a lower side 23. A collar 25 protruding from the lower side 23 surrounds a continuous recess 27 in the center of the contact region 15. The upper side 15 forms a support surface 29 for a contact pin 9 which is to be connected in an electrically conducting manner to the contact element 11. The support surface 29 is the region of the upper side 21 on which the contact pin 9 rests. It is advantageously flat in order to permit good and reliable electrical contact with the contact pin 9 resting thereon. An internal thread 31 is incorporated into the walls of the recess 27, extends along the collar 25 and also extends partially in the region between the upper side 21 and the bottom side 23. The internal thread 31 is spaced apart from the support surface 29 in a direction perpendicular to the support surface 29, such that an upper-side portion of the recess 27 has no thread. This region is an elastically deformable spring region 33 which widens from the internal thread 31 toward the support surface 29, such that its funnel-shaped cross-sectional contour has a curved profile.

The contact region 15 is electrically and mechanically connectable to a contact pin 9 (not illustrated in FIG. 2 and FIG. 3), the end region of which has an external thread 35. The connection is effected by screwing the external thread 35 into the internal thread 31.

FIG. 4 shows a section through a three-dimensional view of a detail of the electric motor, in which the connection of the contact pins 9 projecting through the housing 3 to the contact elements 11 can be seen.

The contact pins 9 have a circular cylindrical basic shape, the end region of which with an external thread 35 has a smaller diameter, such that the shoulder-shaped cross-sectional reduction forms a radial resting surface 37. When the contact pin 9 and the contact element 11 are connected to one another, the external thread 35 engages in the internal thread 31, and the resting surface 37 of the contact pin 9 rests on the support surface 29 of the contact element 15. The threaded connection between the external thread 35 and the internal thread 31 is pre-loaded, wherein the spring region 33 of the contact element 15 is elastically deformed and applies the pre-load. This pre-load prevents the threaded connection from being released in the event of a temperature change or due to vibration. The electrical connection between the contact pin 9 and the contact element 11 takes place both by contact between the internal thread 31 and the external thread 35, which engage in one another, and by contact between the support surface 29 and the resting surface 37, which lie one on top of another. Additional stabilization is brought about by a final potting of the stator region (not illustrated in FIG. 4) which surrounds the non-rotating components in the housing interior, including stator terminal conductors 7 and the contact elements 11 connected to the end regions of the contact pins 9.

The connection between contact pins 9 and the contact elements 11 on the stator terminal conductors 7 of the stator 1 situated in the housing 3 is established in that the contact pin 9 is guided through an opening into the housing interior and, by means of rotation, its external thread 35 is screwed into the internal thread 31 of the contact element 11, held by a tool, until the threaded connection is pre-loaded.

FIG. 5 shows a section through a contact element 11 connected to the contact pin 9. The stator terminal conductor 7 is compressed in the contact element 11. A seal 39 is provided between the contact pin 9 and the housing 3. The end region of the contact pin 9 with the external thread 35 projects through the recess 27 of the contact region 15, wherein the external thread 35 and the internal thread 31 engage in one another and the resting surface 37 presses onto the support surface 29, which is accompanied by a deformation of the spring region 33 owing to the pre-loading of the threaded connection.

The collar 25 and the recess 27 in the contact surface 15 of the contact element 11 are a sheet-metal passage which has been formed by flow forming. A sheet-metal passage is a deformation of a sheet metal in regions, in which, usually proceeding from a pilot hole, a continuous collar is formed in the sheet metal about a recess.

The forming of the recess 27 and the collar 25 is visualized in FIG. 6 on the basis of steps (i) to (v).

In the first step (i), a rotating circular-cylindrical tool with a conical tip, a so-called flow former 41, is placed on the sheet-metal contact region 15. A combination of feed force and rotation of the flow former 41 generates frictional heat and brings about plastic deformation, see step (ii). As opposed to conventional drilling, flow forming, also referred to as thermal drilling, is not a subtractive method. Rather, the flow former 41 causes material displacement and thus forms an opening, see step (iii), which forms the recess 27 with the collar 25 as the penetration of the flow former increases. The material from the region of the opening is forced to the lower side, such that the material forms a bushing-shaped collar 25 on the lower side. After removal of the flow former, the recess 27 is radially delimited on the lower side by the collar 25, see step (iv). The length of the collar 25 can be up to three to four times the thickness of the sheet metal. Subsequently, in a further step (v), an internal thread 31 is formed in the recess 27, which internal thread also extends along the collar 25. This can be effected by a thread cutter 43, either by subtraction or only by deformation without subtraction.

In the case of a pin contact 9 connected to the contact element 11, the external thread 35 of said pin contact engages in said internal thread 31, as illustrated in sub-figure (vi).

The features specified above and in the claims and shown in the figures can be advantageously implemented both individually and in various combinations. The invention is not limited to the exemplary embodiments described, but may be modified in various ways within the scope of the abilities of a person skilled in the art.

### LIST OF REFERENCE SIGNS

1 Stator
3 Housing
7 Stator terminal conductor
9 Contact pin
11 Contact element
13 Crimp region
15 Contact region
17 Conductor receptacle
19 Web
21 Upper side
23 Lower side
25 Collar
27 Recess
29 Support surface
31 Internal thread
33 Spring region
35 External thread
37 Resting surface
39 Seal
41 Flow former
43 Thread cutter

1. A contact element (11) with a crimp region (13) which is designed for crimping onto an electrical conductor, and with a contact region (15) which has a continuous recess (27) that is radially delimited by a collar (25) on a lower side (23) of the contact region (15), wherein the recess (27) has an internal thread (31).

2. The contact element (11) as claimed in claim 1, wherein a flow-formed sheet-metal passage forms the recess (27) and the collar (25).

3. The contact element (11) as claimed in claim 1,
wherein the contact region (15) has an upper side (21) which forms a support surface (29) for a contact pin (9), wherein the internal thread (31) is spaced apart from the support surface (29) in a passing direction extending perpendicularly to the upper side (21).

4. The contact element (11) as claimed in claim 1,
wherein the internal thread (31) extends along an entire length of the collar (25).

5. The contact element (11) as claimed in claim 3,
wherein a spring region (33) between the support surface (29) and the internal thread (31) is elastically deformable.

6. The contact element (11) as claimed in claim 5, wherein the spring region (33) widens radially toward the support surface (29).

7. The contact element (11) as claimed in claim 1,
which is formed integrally from a metal sheet.

8. The contact element (11) as claimed in claim 1,
which is cupreous.

9. The contact element (11) as claimed in claim 1,
wherein the crimp region (13) and the contact region (15) are connected by a web (19), and wherein the crimp region (13) forms a cavity as a conductor receptacle (17), which extends in a longitudinal direction, and peripheral regions of the crimp region (13) extending in the longitudinal direction overlap one another.

10. The contact element (11) as claimed in claim 1,
wherein the contact region (15), which extends from the crimp region (13) in the longitudinal direction, is a sheet-metal region with a rectangular or circular basic shape.

11. A stator assembly with a stator (1) which comprises at least one stator terminal conductor (7), wherein a contact element (11) as claimed in claim 1 claims is fastened to the end region of the stator terminal conductor (7), wherein the contact element (11) is connected in an electrically conducting manner to a contact pin (9), and wherein the contact pin (9) has a contact pin end with an external thread (35) which engages in the internal thread (31) of the contact element (11).

12. The stator assembly as claimed in claim 11,
wherein the contact pin (9) has a resting surface (37) which protrudes radially beyond the external thread (35) and rests on the supporting surface (29) of the contact element (11).

13. The stator assembly as claimed in claim 11,
wherein the external thread (35) and the internal thread (31) engage in one another as a threaded connection in such a manner that a pre-loading force acts on the threaded connection.

14. A method for producing a contact element (11) with a crimp region (13) and a contact region (15), wherein the method comprises forming a recess (27) in the contact region (15) and a collar (25) which radially delimits the recess (27) on a lower side of the contact region (15) by means of flow forming, and forming an internal thread (31) in the recess (27).
